(19) United States
(12) Patent Application Publication
(10) Pub. No.: US 2010/0153588 A1
(43) Pub. Date: Jun. 17, 2010

(54) COMPUTER EXECUTABLE PROGRAM FOR MANAGING MEDIAS

(75) Inventors: Xiao-Guang Li, Shenzhen City (CN); Xiao-Fang Chen, Shenzhen City (CN); Zai-An Pan, Shenzhen City (CN); Ming-Feng Tsai, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HON HAI PRECISION INDUSTRY CO., LTD., Tu-Cheng,Taipei Hsien (TW); HONG FU JIN PRECISION INDUSTRY (ShenZhen) CO., LTD, Shenzhen City (CN)

(21) Appl. No.: 12/427,704

(22) Filed: Apr. 21, 2009

(30) Foreign Application Priority Data
Dec. 16, 2008 (CN) 200810306289.4

(51) Int. Cl. G06F 3/00

(52) U.S. Cl. 710/15; 710/1

(57) ABSTRACT

A computer executable program for managing medias is provided. The computer executable program includes a connection detecting module, a searching module, a removing module, and a downloading module. When the connection detecting module detects a communication connection between a portable electronic device and a computer is established, the searching module searches a first type of medias of the portable electronic device, and the removing module moves the first type of medias from the portable electronic device to the computer. The searching module also searches a second type of medias of the computer, the downloading module downloads the second type of medias from the computer to the portable electronic device.

### 1. RELATED APPLICATIONS

This application is related to a co-pending U.S. patent application filed concurrently herewith whose Attorney Docket No is US 16978 and entitled “ELECTRONIC DEVICE AND METHOD FOR MANAGING MEDIAS,” which is incorporated herein by reference.

### BACKGROUND

1. Technical Field

The disclosure relates to computer executable programs and, particularly, to a computer executable program for managing medias.

2. Description of Related Art

Nowadays, many electronic devices, e.g., mobile phones, digital photo frames, electronic readers (e-reader), are capable of storing and displaying a plurality of digital medias (e.g., digital images, digital texts, etc). Generally, those electronic devices have a limited storage capacity. A user has to spend time to manually delete some medias when the user wants to add new medias to an electronic device, which has no free space left.

Additionally, people often like to download digital medias from a computer or other type of medias storage such as a server to the electronic device, which is also time consuming.

Therefore, it is necessary to provide a computer executable program to overcome the above-identified deficiencies.

### BRIEF DESCRIPTION OF THE DRAWINGS

The components in the drawings are not necessarily drawn to scale, the emphasis instead being placed upon clearly illustrating the principles of the computer executable program. Moreover, in the drawings, like reference numerals designate corresponding parts throughout the several views.

FIG. 1 is a schematic diagram showing an application of a computer executable program for managing medias in accordance with an exemplary embodiment.

FIG. 2 is a block diagram of the computer executable program for managing medias in accordance with an exemplary embodiment.

### DETAILED DESCRIPTION

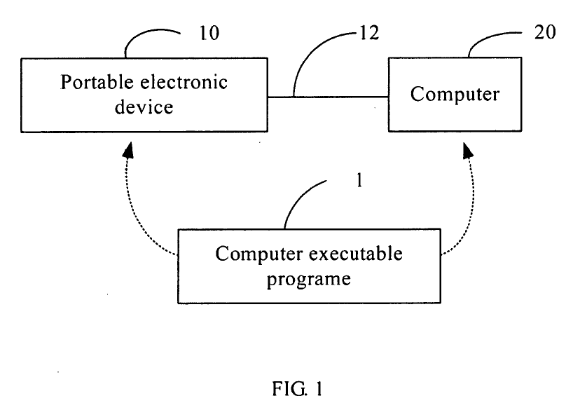

Referring to FIG. 1, In the exemplary embodiment, a computer executable program 1 (or software) for managing medias is employed by a computer to manage medias in a portable electronic device 10. The portable electronic device 10 can be connected to the computer 20 by a data cable 12. The data cable 12 can be a universal serial bus (USB) cable, an IEEE 1394 cable, or the like. In the exemplary embodiment, the computer executable program 1 is an auto-run batch file stored in a computer-readable medium (CRM, not shown), the CRM can be a flash memory, a compact disk, a micro drive, or the like. In another embodiment, the computer executable program 1 is stored in the portable electronic device 10 or the computer 20, the computer executable program 1 also can be a software. When the storage medium is connected to the computer 10 or the portable electronic device 20, and a communication connection is established between the computer 10 and the portable electronic device 20, the computer executable program 1 is invoked and executed by either the computer 10 or the portable electronic device 20. By executing the computer executable program 1, a first type of medias in the portable electronic device 20 are moved to the computer 10, that is, copied to the computer and deleted from the portable electronic device 20, and a second type of medias in the computer 10 are downloaded to the portable electronic device 20.

In the exemplary embodiment, the first type of medias are those which have not been viewed in full size for at least a first predetermined time period (e.g., a month), and the second type of medias are those which have been viewed in full size within a second predetermined time period (e.g., fifteen days). The portable electronic device 20 can be a mobile phone, a digital photo frame, a personal digital assistant (PDA), or the like. The computer 20 can be a home computer, or a server computer. The medias can be digital images, digital text, audio media, or the like. In the embodiments, digital images (hereinafter images) are used as an example to illustrate the present computer executable program.

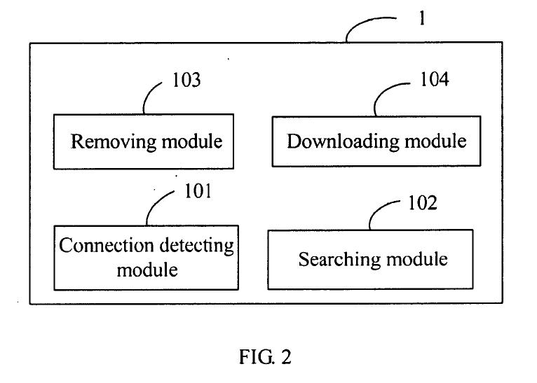

Referring also to FIG. 2, the computer executable program 1 includes a connection detecting module 101, a searching module 102, a removing module 103, and a downloading module 104.

The connection detecting module 101 is configured for detecting whether a communication connection between the portable electronic device 10 and the computer 20 has been established. For example, if the portable electronic device 10 is connected to the computer 20 via a USB cable, a voltage at a USB port of the portable electronic device 10 coupled to a USB port of the computer 20 is changed, the connection detecting module 101 determines the communication connection between the portable electronic device 10 and the computer 20 is established when it detects the voltage change of the port of the portable electronic device 10. The connection detecting module 101 outputs a trigger signal when it determines the communication connection between the portable electronic device 10 and the computer 20 is established. In another exemplary, the portable electronic device 10 and the computer 20 are connected to each other in a wireless mode.

The searching module 102 is configured to search for the first type of images in the portable electronic device 20 after the communication connection between the computer 10 and the electronic device 1 is established. Usually, a record is kept by a media viewer (not shown) of the portable electronic device 20 when a medias is accessed and viewed by a user employing the media viewer. The record includes the date and time the media was accessed. In the embodiment, the media viewer is an image viewer, a record is kept by the image viewer when an image is viewed in full size. The searching module 102 searches the records kept by the image viewer and determines if there are any of the first type of images. For example, if there is no record of an image within the first predetermined time period, the searching module 102 determines the image is the first type of images.

The removing module 103 is configured to move any found first type of images to the computer 10.

The searching module 102 is also configured to search for any of the second type of images in the computer 10. The searching module 102 searches for the second type of images according to search criteria preset by the user or the software maker. In the exemplary embodiment, the search criteria preset by the user is to search for the images that have been recently viewed in full size, that is, within a second predetermined time period, for example, to search through all images in the computer for the images that have been accessed and viewed in the past fifteen days. In one embodiment, the functions of the searching module 102 may be performed by a standard search module of the computers operating system. The downloading module 104 is configured to download the second type of images from the computer 20 to the portable electronic device 10.

In the exemplary embodiment, the modules of the computer executable program 1 are executed by either the portable electronic device 10 or the computer 20. In another embodiment, part of modules of the computer executable program 1 are executed by the portable electronic device 10 and the others are executed by the computer 20. For example, the connection detecting module 101, the searching module 102, and the removing module 103 are executed by the portable electronic device 10, and the downloading module 104 is executed by the computer 20.

The first predetermined time period and the second predetermined time period can be set by the user, or provided in the portable electronic device 10 as system defaults.

In an alternative embodiment, the first type of images are those which have been viewed less than a first predetermined times in the first predetermined time period, and the second type of images are those which have been viewed more than a second predetermined times in the second predetermined time period.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A computer executable program for managing images, the computer executable program is applied to a computer and a portable electronic device which are interconnected with each other, wherein, the computer executable program comprises:
a connection detecting module configured for detecting whether a communication connection is established between the portable electronic device and the computer and producing a trigger signal on condition of the communication connection is established;
a searching module configured for searching a first type of medias in the portable electronic device when receiving the trigger signal; and
a removing module configured for moving the first type of medias from the portable electronic device to the computer.

2. The computer executable program of claim 1, wherein the searching module is further configured for searching a second type of medias in the computer when the communication connection between the computer and the portable electronic device is established; and the computer executable program further comprises a downloading module configured for downloading the second type of medias from the computer to the portable electronic device.

3. The computer executable program of claim 2, wherein the computer executable program is an auto-run batch file which can be invoked by either the computer or the portable electronic device.

4. The computer executable program of claim 2, wherein the modules of the computer executable program are executed by either the computer or the portable electronic device.

5. The computer executable program of claim 2, wherein part of modules of the computer executable program are executed by the computer and the others are executed by the portable electronic device.

6. The computer executable program of claim 1, wherein the image searching module is further configured for searching the first type of medias according to records kept by a media viewer of the portable electronic device, the records comprises date and time the medias accessed.

7. The computer executable program of claim 1, wherein the first type of medias are those medias which have not been viewed in full size exceed a first predetermined time period or have been viewed less than a predetermined times in the first predetermined time period.

8. The computer executable program of claim 1, wherein the second type of medias are those medias which have been viewed in full size in a second predetermined time period.

9. The computer executable program of claim 1, wherein the media is selected from the group consisting of a digital image, a digital text, and an audio media.

10. A computer-readable medium (CRM) having stored thereon a computer executable program, for managing medias, that applied in a computing system which includes a computer connected to a portable electronic device, when executed by the computing system, causing the system to:
detect whether a communication connection is established between the portable electronic device and the computer and producing a trigger signal on condition of the communication connection is established by executing a connection detecting module of the computer executable program;
search a first type of medias in the portable electronic device when receiving the trigger signal by executing a searching module of the computer executable program; and
move the first type of medias from the portable electronic device to the computer by executing a removing module of the computer executable program.

11. The CRM of claim 10, wherein the CRM further causes the system to:
search a second type of medias in the computer when the communication connection between the computer and the portable electronic device is established by executing the searching module of the computer executable program, and
download the second type of medias from the computer to the portable electronic device by executing a downloading module of the computer executable program.

12. The CRM of claim 11, wherein the computer executable program is an auto-run batch file which can be invoked by either the computer or the portable electronic device.

13. The CRM of claim 11, wherein the modules of the computer executable program are executed by either the computer or the portable electronic device.

14. The CRM of claim 11, wherein part of modules of the computer executable program are executed by the computer and the others are executed by the portable electronic device.
